(19) United States
(12) Patent Application Publication
(10) Pub. No.: US 2011/0067634 A1
(43) Pub. Date: Mar. 24, 2011

(54) Fish feed dispenser

(76) Inventor: Gary Wayne Rossin, Johnston City, IL (US)

(21) Appl. No.: 12/586,202

(22) Filed: Sep. 19, 2009

(51) Int. Cl. A01K 61/02

(52) U.S. Cl. 119/51.04

(57) ABSTRACT

An apparatus for storing, grinding, and dispensing flake style fish feed for the purpose of feeding fish in an a aquarium. The apparatus having an upper hopper for receiving a quantity of flake fish feed, a grinding mechanism in the lower portion of the upper hopper for breaking down the larger feed flakes into smaller, more uniform flakes. A method of separating out the smaller flakes and depositing them into a lower hopper where the feed can be stored or fed directly to the fish

### FIELD OF THE INVENTION

The present invention relates to animal feeders and feed dispensers, and aquarium fish feeding devices in particular. A method of receiving, grinding, storing, and dispensing flake fish feed for the purpose of feeding fish in an aquarium.

### RELATED FIELDS

Aquarium's are water filled tanks, usually constructed of a metal frame with glass sides and bottom. The term “aquarium” applies to tanks used to keep fish and other aquatic life for their decorative effect, interesting habits, and scientific study of aquatic life.

Proper feeding of aquarium fish is a critical part of their care, and over feeding of fish is a common problem that, if not corrected, causes elevated levels of ammonia and other water quality problems that can be harmful or fatal to the fish and other aquatic life. When fish are fed more than they consume in a few minutes, a portion of the feed settles into the media in the bottom of the aquarium and some of the feed is drawn into and held by the aquarium's water filtration system. This wastes feed and clogs the water filter media with uneaten food, causing potential health problems for the fish and other aquatic life due to elevated levels of toxic substances in the water.

Most overfeeding problems occur when the pet owner is trying to shake feed out of the container and into the aquarium. Due to the large variation in the size of the flakes in the container it is very difficult to dispense consistent amounts of feed each time. Presently the only methods of dispensing flake feed is to shake it from the container or to remove small amounts from the container using your fingers. It is difficult to dispense consistent amounts of feed by shaking it out of the container due to the variation of flake sizes in the container and most people do not like to pick up the feed with their fingers due to the unpleasant odor and feed residue this leaves on their hands.

There exists a need for a simple, inexpensive, and easy to use method of producing more uniform sized pieces of flake feed and a method for delivering the feed to the fish in an aquarium without direct human contact with the feed.

The present invention addresses these needs with an apparatus that stores flake feed, grinds the feed into smaller more uniform size flakes, and can deliver the feed into the aquarium without human contact with the feed.

### SUMMARY OF INVENTION

The objective of the present invention is to provide a method of storing, grinding, and dispensing flake feed in consistent uniform amounts each time the fish are fed.

Another objective of the present invention is to deliver the feed to the fish in more uniformly sized pieces which will provide a better opportunity for all the fish to get their share of the feed.

Another further objective of the present invention is to enable the pet owner to feed their fish without having to shake the feed out of the container, or by pinching feed out of the container with their fingers. The present invention meets these requirement with a simple system that can be manufactured inexpensively with readily available components.

### BRIEF DESCRIPTION OF DRAWINGS

FIG. 1 Is a sectional view of the present invention in a preferred embodiment illustrating certain features.

FIG. 2 is a sectional view of the present invention in a preferred embodiment illustrating certain features.

FIG. 3 is a sectional view of the present invention in a second preferred embodiment illustrating certain features.

FIG. 4 is a sectional view of the present invention in a second preferred embodiment illustrating certain features.

### DESCRIPTION OF OPERATION OF PREFERRED EMBODIMENTS

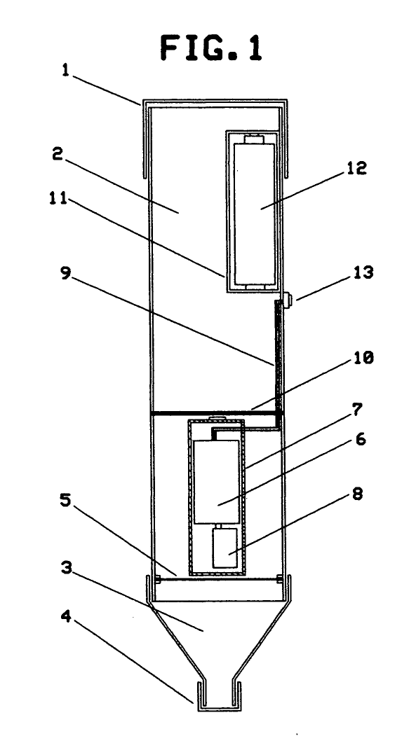

FIG. 1 illustrates a fish feeder in a preferred embodiment consisting of a hopper cap (1), an upper hopper (2), lower hopper (3), lower hopper cap (4), wire mesh divider (5), agitator motor (6), agitator housing (7), eccentric weight (8), motor wires (9), retainer wire (10), battery housing (11), battery (12), and power switch (13).

In accordance with one aspect of the present invention as illustrated in FIG. 1, an upper hopper (2) for receiving and storing an amount of flake fish feed. A hopper cover (1) for holding the feed within the upper hopper.

In accordance with another aspect of the present invention a lower hopper (3) being funnel shaped for the purpose of receiving ground up flake feed from the upper hopper that has been reduced in size sufficiently that it passes through the wire mesh divider (5) between the upper and lower hopper.

In accordance with another aspect of the present invention a wire mesh divider (5) that is glued or otherwise affixed to a ridge or a grove around the inside circumference at the lower end of the upper hopper.

In accordance with another aspect of the present invention a vibration motor (6) encapsulated in a vibration motor housing (7) the vibration motor being an electrically driven motor with it's output shaft being rotatably coupled to a eccentric weight which causes the motor to oscillate at 90 degrees to the motor axis when the motor shaft rotates. The vibration motor housing sits loosely inside the upper hopper (2) with the bottom of vibrating motor housing in contact with the upper surface of the wire mesh divider (5). Power is supplied to the vibration motor from the battery (12) located in the battery hopper (11). Electrical current flows through the power switch (13) through motor wires (9), the oscillating action of the vibration motor crushes the flake feed

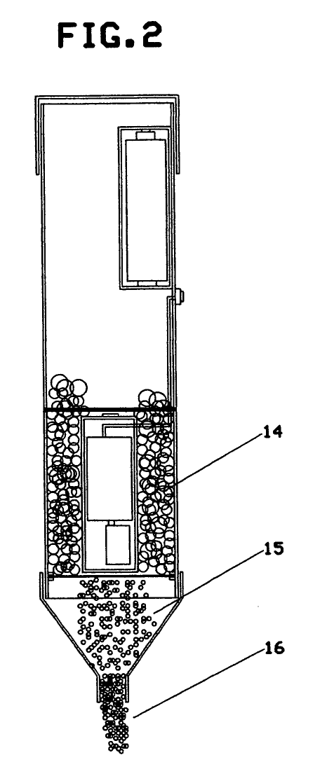

FIG. 2. (14) against the inside circumference of the upper hopper breaking down the feed flakes into smaller pieces. A further grinding action of the feed occurs as the vibration motor housing rubs against feed that moves downward and between the vibration motor housing (7) and the upper surface of the wire mesh divider (5). These smaller pieces of feed pass through the wire mesh divider and into the lower hopper FIG. 2 (15). This feed can be stored in the lower hopper for later use or with the lower hopper cap removed, the feed is directly dispensed into the aquarium FIG. 2 (16). Excess movement of the vibration motor vertically within the upper hopper FIG. 1 (2) is restricted by a retainer wire FIG. 1 (10) which keeps the vibration motor housing in close proximity to the wire mesh divider. FIG. 1 (5).

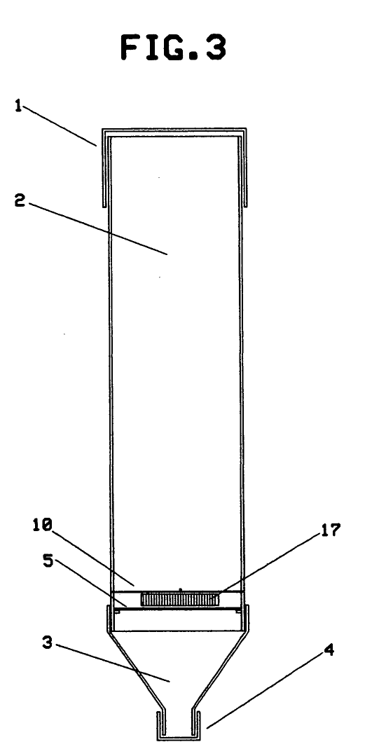

In accordance with yet another preferred embodiment illustrated in FIG. 3 the present invention can be operated manually by replacing the vibration motor FIG. 1 (6) with an agitator cylinder FIG. 3 (17) being a round metal cylinder. When the embodiment in FIG. 3 is manually shaken side to side at a 90 degree angle to the axis of the hopper, the

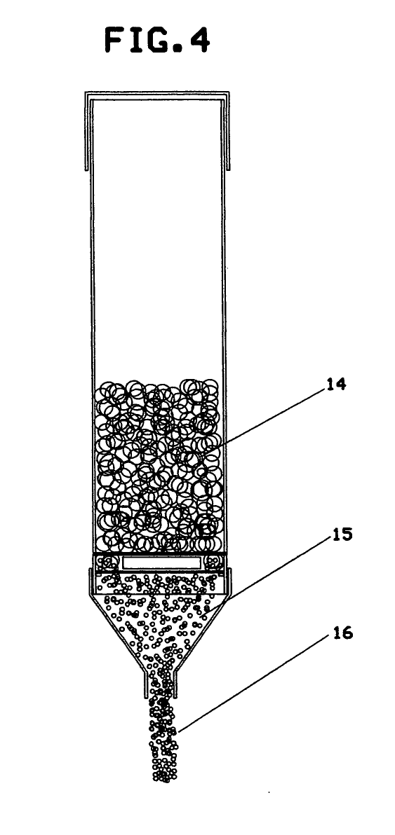

agitator cylinder FIG. 3 (17) crushes feed against the inside circumference of the upper housing FIG. 4 (14). These smaller feed particles pass through the wire mesh divider (5) and into the lower hopper FIG. 4 (15) for storage or depositing directly into the aquarium FIG. 4 (16).

The feeder can be operated by electrical means to directly feed the fish in an aquarium. It could also be mounted to the aquarium and run automatically being controlled internally or remotely by electronic timing, to control the frequency of feeding and the amount of feed dispensed. In the manual embodiment of FIG. 3 and FIG. 4 the feeder is a manually powered device used for feeding the fish by dropping the feed into the aquarium water for each feeding cycle.

The foregoing descriptions of the invention have been presented for purposes of illustration of the invention. It is not intended to limit the invention to the precise form or use disclosed. The embodiments were chosen and described to explain the principals and practical application of the invention. Alterations and modifications which readily suggest themselves to persons skilled in the art without departing from the true spirit of the disclosed invention are intended to be included in the scope of the invention.

I claim:

1. A flake fish feed dispenser comprising;
A cylinder shaped housing embodying upper and lower feed hoppers.
Having an upper feed hopper for receiving and holding flake style fish feed.
Having a motorized or manual feed agitator assembly within the upper feed hopper.
Having a divider grid located between the upper and lower feed hoppers.
Having a lower feed hopper for receiving resized feed from the upper hopper.

2. The apparatus of claim 1, wherein, the upper hopper is cylindrical in shape and has a removable cover for receiving flake fish feed.

3. The apparatus of claim 1, wherein, the motorized agitator is an electric motor that is enclosed in a sealed housing, having an eccentric weight connected to the motors rotatable shaft.

4. The apparatus of claim 1, wherein, in a non motorized embodiment the agitator assembly is a hollow or solid weight that is flat on its lower surface.

5. The apparatus of claim 1, wherein, a battery compartment and momentary contact switch are contained within the outer wall of the upper hopper.

6. The apparatus of claim 3, wherein, the motorized agitator is electrically coupled to the battery compartment and the momentary contact switch with wires of sufficient flexibility and length to allow the agitator assembly to move about freely horizontally within the interior of the upper hopper.

7. The apparatus of claim 6, wherein, the vertical movement of the agitator assembly within the upper hopper is limited by one or more retainer wires or bars mounted just above the agitator assembly These wires or bars will span across the interior walls of the upper hopper.

8. The apparatus of claim 1, wherein, the divider between the upper and lower hoppers is a grid constructed of wire, metal, or plastic. The upper surface of the grid is uneven, with alternating high and low points at each grid intersection.

9. The apparatus of claim 1, wherein the lower hopper is funnel shaped with a removable cap on the lower end for the dispensing of flake feed.
